(19) United States
(12) Patent Application Publication
(10) Pub. No.: US 2020/0133146 A1
(43) Pub. Date: Apr. 30, 2020

(54) ELECTROPHOTOGRAPHIC PHOTOSENSITIVE MEMBER, PROCESS CARTRIDGE, AND ELECTROPHOTOGRAPHIC APPARATUS

(71) Applicant: CANON KABUSHIKI KAISHA, Tokyo (JP)

(72) Inventors: Tsuyoshi Shimada, Kashiwa-shi (JP); Kumiko Takizawa, Saitama-shi (JP); Ikuyo Kuroiwa, Tokyo (JP); Kan Tanabe, Matsudo-shi (JP); Haruhiko Mitsuda, Nagareyama-shi (JP); Tatsuya Ikezue, Toride-shi (JP); Takanori Ueno, Nagareyama-shi (JP)

(21) Appl. No.: 16/601,994

(22) Filed: Oct. 15, 2019

(30) Foreign Application Priority Data
Oct. 25, 2018 (JP) 2018-201293

(51) Int. Cl. G03G 5/06; G03G 15/02; G03G 5/05

(52) U.S. Cl. CPC G03G 5/0696; G03G 5/0564; G03G 5/0542; G03G 15/0258

(57) ABSTRACT

Provided are an electrophotographic photosensitive member excellent in suppression of the occurrence of a photomemory, and a process cartridge and an electrophotographic apparatus each including the electrophotographic photosensitive member. The electrophotographic photosensitive member includes in this order: an electroconductive support; an undercoat layer; and a photosensitive layer, wherein the undercoat layer contains strontium titanate particles and a binder resin, and the photosensitive layer contains a butanediol adduct of titanyl phthalocyanine.

### BACKGROUND OF THE INVENTION

### Field of the Invention

The present disclosure relates to an electrophotographic photosensitive member, and to a process cartridge and an electrophotographic apparatus each including the electrophotographic photosensitive member.

### Description of the Related Art

In recent years, as an organic electrophotographic photosensitive member (hereinafter referred to as “electrophotographic photosensitive member”), an electrophotographic photosensitive member including an undercoat layer containing metal oxide particles and a photosensitive layer formed on the undercoat layer has been used.

In general, a high-sensitivity charge-generating substance is incorporated into the photosensitive layer for improving the sensitivity of the electrophotographic photosensitive member.

For example, as a technology of suppressing fluctuations in characteristics of the electrophotographic photosensitive member due to an environmental change while achieving an improvement in sensitivity of the electrophotographic photosensitive member, in Japanese Patent Application Laid-Open No. H05-273775, there is a disclosure of a technology involving incorporating a butanediol adduct of titanyl phthalocyanine into the photosensitive layer.

Meanwhile, as disclosed in Japanese Patent Application Laid-Open No. 2015-114646, a configuration in which titanium oxide particles are incorporated into the undercoat layer and a butanediol adduct of titanyl phthalocyanine is incorporated into the photosensitive layer has involved a problem in that light-induced fatigue (photomemory) is liable to occur.

### SUMMARY OF THE INVENTION

The present disclosure relates to an electrophotographic photosensitive member including in this order: an electroconductive support; an undercoat layer; and a photosensitive layer, wherein the undercoat layer contains strontium titanate particles and a binder resin, and the photosensitive layer contains a butanediol adduct of titanyl phthalocyanine, and to a process cartridge and an electrophotographic apparatus each including the electrophotographic photosensitive member.

Further features of the present disclosure will become apparent from the following description of exemplary embodiments with reference to the attached drawings.

### BRIEF DESCRIPTION OF THE DRAWINGS

FIG. 1 is a view for illustrating an example of the layer configuration of an electrophotographic photosensitive member according to one aspect of the present disclosure.

FIG. 2 is a view for illustrating an example of an electrophotographic apparatus including a process cartridge including the electrophotographic photosensitive member according to one aspect of the present disclosure.

### DESCRIPTION OF THE EMBODIMENTS

The present inventors have made an investigation on the above-mentioned problem, and as a result, have found that the use of strontium titanate particles as the metal oxide particles to be incorporated into the undercoat layer can suppress the occurrence of the light-induced fatigue (photomemory) when the butanediol adduct of titanyl phthalocyanine is used as a charge-generating substance in the photosensitive layer.

Therefore, it is an object of the present disclosure to provide an electrophotographic photosensitive member excellent in suppression of the occurrence of a photomemory when a butanediol adduct of titanyl phthalocyanine is used as a charge-generating substance in its photosensitive layer, and a process cartridge and an electrophotographic apparatus each including the electrophotographic photosensitive member.

An electrophotographic photosensitive member, and a process cartridge and an electrophotographic apparatus each including the electrophotographic photosensitive member according to one aspect of the present disclosure are such that the undercoat layer of the electrophotographic photosensitive member contains strontium titanate particles and the photosensitive layer thereof contains a butanediol adduct of titanyl phthalocyanine.

The present inventors have made extensive investigations, and as a result, have found that, when the butanediol adduct of titanyl phthalocyanine is used as a charge-generating substance in the photosensitive layer, the incorporation of the strontium titanate particles into the undercoat layer is important for the suppression of the occurrence of a photomemory.

Although a detailed reason for the foregoing is unclear, the butanediol adduct of titanyl phthalocyanine has high sensitivity, and hence originally generates a large quantity of charge with respect to light exposure. Accordingly, the butanediol adduct of titanyl phthalocyanine has the following property: charge retention is liable to occur in the photosensitive layer or between the photosensitive layer and the undercoat layer, and hence the photomemory is liable to occur.

Further, the addition of butanediol having an electron-donating property is expected to change the energy level of titanyl phthalocyanine.

The energy level of the strontium titanate particles has better compatibility with that of the butanediol adduct of titanyl phthalocyanine than that of titanium oxide particles does, and hence the strontium titanate particles are considered to be advantageous for charge exchange.

Probably because of the foregoing, in the case where the undercoat layer contains the strontium titanate particles, charge retention between the photosensitive layer and the undercoat layer caused by strong light exposure is suppressed as compared to the case where the undercoat layer contains only the titanium oxide particles, and hence the occurrence of the photomemory can be suppressed.

In addition, a case in which the butanediol adduct of titanyl phthalocyanine has a structure represented by the following formula (1) is preferred because the occurrence of the photomemory is further suppressed, and a case in which the butanediol adduct of titanyl phthalocyanine has a structure represented by the following formula (2) is more preferred.

This is probably because of the following reason: the energy level of the butanediol adduct of titanyl phthalocyanine is changed by the structure of butanediol to be added, and hence a structure whose energy level has satisfactory compatibility with that of the strontium titanate particles is a structure represented by the following formula (1) or the following formula (2).

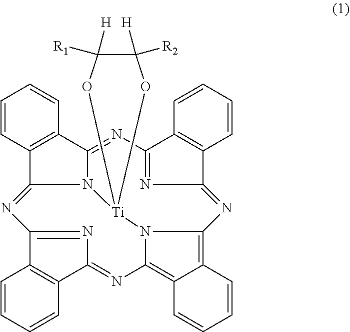

In the formula (1), R₁ and R₂ each represent a hydrogen atom, or an alkyl group having 2 or less carbon atoms, and a total number of carbon atoms of R₁ and R₂ is 2.

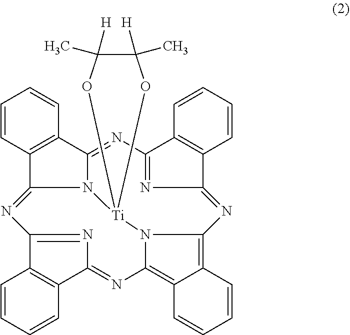

In addition, a case in which the photosensitive layer further contains non adduct of titanyl phthalocyanine is preferred because the occurrence of the photomemory is further suppressed, and a case in which the non adduct of titanyl phthalocyanine is represented by the following formula (3) is more preferred.

This is probably because, when the photosensitive layer contains the non adduct of titanyl phthalocyanine, compatibility between the energy levels of the butanediol adduct of titanyl phthalocyanine and the strontium titanate particles may be further improved.

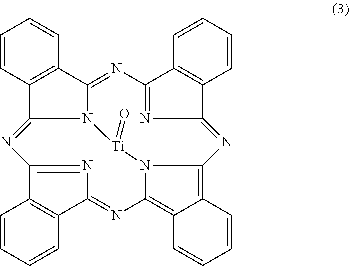

The undercoat layer of the electrophotographic photosensitive member according to one aspect of the present disclosure contains the strontium titanate particles and a binder resin.

Although the number-average particle diameter of the primary particles of the strontium titanate particles to be incorporated into the undercoat layer of the electrophotographic photosensitive member according to one aspect of the present disclosure is not particularly limited, the number-average particle diameter is preferably 150 nm or less from the viewpoint of the suppression of the occurrence of the photomemory.

This is probably because, when the sizes of the strontium titanate particles to be incorporated into the undercoat layer become smaller to some extent, the area of contact between the particles and the butanediol adduct of titanyl phthalocyanine in the photosensitive layer can be increased, and the increased contact area is advantageous for charge exchange.

The strontium titanate particles to be incorporated into the undercoat layer of the electrophotographic photosensitive member according to one aspect of the present disclosure may be subjected to a surface treatment as required. Various methods have been known as methods for the surface treatment, and examples thereof may include: a method involving causing a surface treatment agent to adsorb to, or react with, the surfaces of the strontium titanate particles to perform the surface treatment; and a method involving exposing the particles to a water vapor atmosphere to subject the particles to a humidification treatment. Those surface treatment methods may be used in combination thereof.

When the surface treatment agent is used, a silane coupling agent may be suitably used as the surface treatment agent.

Examples of the silane coupling agent include N-2-(aminoethyl)-3-aminopropylmethyldimethoxysilane, 3-aminopropylmethyldiethoxysilane, (phenylaminomethyl)methyldimethoxysilane, N-2-(aminoethyl)-3-aminoisobutylmethyldimethoxysilane, N-ethylaminoisobutylmethyldiethoxysilane, N-methylaminopropylmethyldimethoxysilane, vinyltrimethoxysilane, 3-aminopropyltriethoxysilane, N-(2-aminoethyl)-3-aminopropyltrimethoxysilane, methyltrimethoxysilane, 3-glycidoxypropyltrimethoxysilane, 3-methacryloxypropyltrimethoxysilane, 3-chloropropyltrimethoxysilane, and 3-mercaptopropyltrimethoxysilane.

In addition, the strontium titanate particles to be incorporated into the undercoat layer of the electrophotographic photosensitive member according to one aspect of the present disclosure are preferably incorporated at a content of 30 mass % or more with respect to the mass of the entirety of the undercoat layer from the viewpoints of the electrical characteristics of the photosensitive member, and are more preferably incorporated at a content of 50 mass % or more with respect thereto from the viewpoint of the suppression of the occurrence of the photomemory.

This is probably because, when the strontium titanate particles are incorporated in a somewhat large amount into the undercoat layer, the number of sites of contact between the particles and the butanediol adduct of titanyl phthalocyanine in the photosensitive layer increases, and the increased sites are advantageous for charge exchange.

In addition, the ratio of the content of the strontium titanate particles to be incorporated into the undercoat layer of the electrophotographic photosensitive member according to one aspect of the present disclosure to the mass of the entirety of the undercoat layer is preferably 90 mass % or less from the viewpoint of the film formability of the layer.

Examples of the binder resin to be incorporated into the undercoat layer include an acrylic resin, an allyl resin, an alkyd resin, an ethylcellulose resin, an ethylene-acrylic acid copolymer, an epoxy resin, a casein resin, a silicone resin, a gelatin resin, a phenol resin, a butyral resin, a polyacrylate resin, a polyacetal resin, a polyamideimide resin, a polyamide resin, a polyallyl ether resin, a polyimide resin, a polyurethane resin, a polyester resin, a polyethylene resin, a polycarbonate resin, a polystyrene resin, a polysulfone resin, a polyvinyl alcohol resin, a polybutadiene resin, and a polypropylene resin. Of those, a polyamide resin and a polyurethane resin may be suitably used.

[Electrophotographic Photosensitive Member]

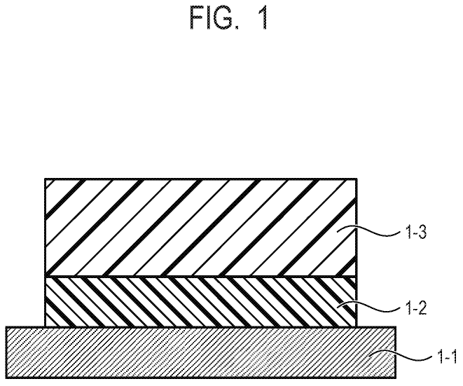

The electrophotographic photosensitive member according to one aspect of the present disclosure includes the undercoat layer on a support, and further includes the photosensitive layer on the undercoat layer as illustrated in, for example, FIG. 1. In FIG. 1, the support is represented by reference numeral 1-1, the undercoat layer is represented by reference numeral 1-2, and the photosensitive layer is represented by reference numeral 1-3.

A method of producing the electrophotographic photosensitive member according to one aspect of the present disclosure is, for example, a method involving: preparing coating liquids for the respective layers to be described later; applying the liquids in a desired layer order; and drying the liquids. At this time, a method of applying each of the coating liquids is, for example, dip coating, spray coating, inkjet coating, roll coating, die coating, blade coating, curtain coating, wire bar coating, or ring coating. Of those, dip coating is preferred from the viewpoints of efficiency and productivity.

<Support>

In one aspect of the present disclosure, the electrophotographic photosensitive member includes the support 1-1. In one aspect of the present disclosure, the support 1-1 is preferably an electroconductive support having electroconductivity. In addition, examples of the shape of the support 1-1 include a cylindrical shape, a belt shape, and a sheet shape. Of those, a cylindrical support is preferred. In addition, the surface of the support may be subjected to, for example, an electrochemical treatment, such as anodization, a blast treatment, or a cutting treatment.

A metal, a resin, glass, or the like is preferred as a material for the support 1-1. Examples of the metal include aluminum, iron, nickel, copper, gold, and stainless steel, and alloys thereof. Of those, an aluminum support using aluminum is preferred.

In addition, electroconductivity may be imparted to the resin or the glass through a treatment involving, for example, mixing or coating the resin or the glass with an electroconductive material.

<Electroconductive Layer>

In one aspect of the present disclosure, an electroconductive layer may be arranged on the support 1-1. The arrangement of the electroconductive layer can conceal flaws and irregularities in the surface of the support, and control the reflection of light on the surface of the support.

The electroconductive layer preferably contains electroconductive particles and a resin.

A material for the electroconductive particles is, for example, a metal oxide, a metal, or carbon black. Examples of the metal oxide include zinc oxide, aluminum oxide, indium oxide, silicon oxide, zirconium oxide, tin oxide, titanium oxide, magnesium oxide, antimony oxide, and bismuth oxide. Examples of the metal include aluminum, nickel, iron, nichrome, copper, zinc, and silver. Of those, a metal oxide is preferably used as the electroconductive particles, and in particular, titanium oxide, tin oxide, and zinc oxide are more preferably used. When the metal oxide is used as the electroconductive particles, the surface of the metal oxide may be treated with a silane coupling agent or the like, or the metal oxide may be doped with an element, such as phosphorus or aluminum, or an oxide thereof.

In addition, each of the electroconductive particles may be of a laminated construction having a core particle and a coating layer coating the particle. Examples of the core particle include titanium oxide, barium sulfate, and zinc oxide. The coating layer is, for example, a metal oxide, such as tin oxide.

In addition, when the metal oxide is used as the electroconductive particles, their volume-average particle diameter is preferably 1 nm or more and 500 nm or less, more preferably 3 nm or more and 400 nm or less.

Examples of the resin include a polyester resin, a polycarbonate resin, a polyvinyl acetal resin, an acrylic resin, a silicone resin, an epoxy resin, a melamine resin, a polyurethane resin, a phenol resin, and an alkyd resin.

In addition, the electroconductive layer may further contain a concealing agent, such as a silicone oil, resin particles, or titanium oxide.

The average thickness of the electroconductive layer is preferably 1 μm or more and 50 μm or less, particularly preferably 3 μm or more and 40 μm or less.

The electroconductive layer may be formed by: preparing a coating liquid for an electroconductive layer containing the above-mentioned respective materials and a solvent; forming a coat of the coating liquid; and drying the coat. Examples of the solvent to be used for the coating liquid include an alcohol-based solvent, a sulfoxide-based solvent, a ketone-based solvent, an ether-based solvent, an ester-based solvent, and an aromatic hydrocarbon-based solvent. As a dispersion method for dispersing the electroconductive particles in the coating liquid for an electroconductive layer, there are given methods using a paint shaker, a sand mill, a ball mill, and a liquid collision-type high-speed disperser.

<Undercoat Layer>

In one aspect of the present disclosure, the undercoat layer 1-2 is arranged on the support 1-1 or the electroconductive layer.

As described above, the undercoat layer 1-2 of the electrophotographic photosensitive member according to one aspect of the present disclosure contains the strontium titanate particles and the binder resin.

In addition, the undercoat layer 1-2 of the electrophotographic photosensitive member according to one aspect of the present disclosure may further contain an electron-transporting substance, a metal oxide, a metal, an electroconductive polymer, and the like for the purpose of improving electric characteristics. Of those, an electron-transporting substance and a metal oxide are preferably used.

Examples of the electron-transporting substance include a quinone compound, an imide compound, a benzimidazole compound, a cyclopentadienylidene compound, a fluorenone compound, a xanthone compound, a benzophenone compound, a cyanovinyl compound, a halogenated aryl compound, a silole compound, and a boron-containing compound. Of those, a benzophenone compound may be suitably used. An electron-transporting substance having a polymerizable functional group may be used as the electron-transporting substance and copolymerized with a monomer having a polymerizable functional group to form an undercoat layer as a cured film.

Examples of the metal oxide include indium tin oxide, tin oxide, indium oxide, titanium oxide, zinc oxide, aluminum oxide, and silicon dioxide. Examples of the metal include gold, silver, and aluminum.

In addition, organic resin particles or a leveling agent may be further incorporated into the undercoat layer 1-2 for the purpose of, for example, adjusting its surface roughness or alleviating its cracking. Hydrophobic organic resin particles, such as silicone particles, or hydrophilic organic resin particles, such as crosslinked polymethyl methacrylate (PMMA) particles, may be used as the organic resin particles. In particular, when PMMA particles are used, adhesiveness between the undercoat layer 1-2 and a charge-generating layer to be formed thereon is improved, and hence a fluctuation in potential of the photosensitive member at the time of repeated use of the photosensitive member can be suppressed. Examples of the leveling agent include a silicone oil and a fluorine-based oil.

The average thickness of the undercoat layer 1-2 is preferably 0.1 μm or more and 50 μm or less, more preferably 0.2 μm or more and 40 μm or less, still more preferably 0.3 μm or more and 30 μm or less.

The undercoat layer 1-2 may be formed by: preparing a coating liquid for an undercoat layer containing the above-mentioned respective materials and a solvent; forming a coat of the coating liquid; and drying and/or curing the coat. Examples of the solvent to be used for the coating liquid include an alcohol-based solvent, a ketone-based solvent, an ether-based solvent, an ester-based solvent, and an aromatic hydrocarbon-based solvent.

<Photosensitive Layer>

The photosensitive layers 1-3 of the electrophotographic photosensitive members according to one aspect of the present disclosure are mainly classified into (1) a laminated photosensitive layer and (2) a single-layer photosensitive layer. (1) The laminated photosensitive layer has a charge-generating layer containing a charge-generating substance and a charge-transporting layer containing a charge-transporting substance. (2) The single-layer photosensitive layer is a single layer containing both a charge-generating substance and a charge-transporting substance.

(1) Laminated Photosensitive Layer

The laminated photosensitive layer has the charge-generating layer and the charge-transporting layer.

(1-1) Charge-Generating Layer

In one aspect of the present disclosure, when the photosensitive layer is the laminated photosensitive layer, the butanediol adduct of titanyl phthalocyanine is incorporated into the charge-generating layer.

In addition, any other charge-generating substance may be further incorporated into the charge-generating layer in one aspect of the present disclosure. Examples of the other charge-generating substance include an azo pigment, a perylene pigment, a polycyclic quinone pigment, an indigo pigment, and a phthalocyanine pigment. Of those, the above-mentioned non adduct of titanyl phthalocyanine is preferably incorporated thereinto.

In addition, a resin is preferably incorporated into the charge-generating layer. Examples of the resin include a polyester resin, a polycarbonate resin, a polyvinyl acetal resin, a polyvinyl butyral resin, an acrylic resin, a silicone resin, an epoxy resin, a melamine resin, a polyurethane resin, a phenol resin, a polyvinyl alcohol resin, a cellulose resin, a polystyrene resin, a polyvinyl acetate resin, and a polyvinyl chloride resin. Of those, a polyvinyl butyral resin is more preferred.

In addition, the charge-generating layer may further contain an additive, such as an antioxidant or a UV absorber. Specific examples thereof include a hindered phenol compound, a hindered amine compound, a sulfur compound, a phosphorus compound, and a benzophenone compound.

The average thickness of the charge-generating layer is preferably 0.1 μm or more and 1 μm or less, more preferably 0.15 μm or more and 0.4 μm or less.

The charge-generating layer may be formed by: preparing a coating liquid for a charge-generating layer containing the above-mentioned respective materials and a solvent; forming a coat of the coating liquid; and drying the coat. Examples of the solvent to be used for the coating liquid include an alcohol-based solvent, a sulfoxide-based solvent, a ketone-based solvent, an ether-based solvent, an ester-based solvent, and an aromatic hydrocarbon-based solvent.

(1-2) Charge-Transporting Layer

The charge-transporting layer preferably contains the charge-transporting substance and a resin.

Examples of the charge-transporting substance include a polycyclic aromatic compound, a heterocyclic compound, a hydrazone compound, a styryl compound, an enamine compound, a benzidine compound, a triarylamine compound, and a resin having a group derived from each of those substances. Of those, a triarylamine compound and a benzidine compound are preferred.

The content of the charge-transporting substance in the charge-transporting layer is preferably 25 mass % or more and 70 mass % or less, more preferably 30 mass % or more and 55 mass % or less with respect to the total mass of the charge-transporting layer.

Examples of the resin include a polyester resin, a polycarbonate resin, an acrylic resin, and a polystyrene resin. Of those, a polycarbonate resin and a polyester resin are preferred. A polyarylate resin is particularly preferred as the polyester resin.

A content ratio (mass ratio) between the charge-transporting substance and the resin is preferably from 4:10 to 20:10, more preferably from 5:10 to 12:10.

In addition, the charge-transporting layer may contain an additive, such as an antioxidant, a UV absorber, a plasticizer, a leveling agent, a lubricity-imparting agent, or a wear resistance-improving agent. Specific examples thereof include a hindered phenol compound, a hindered amine compound, a sulfur compound, a phosphorus compound, a benzophenone compound, a siloxane-modified resin, a silicone oil, fluorine resin particles, polystyrene resin particles, polyethylene resin particles, silica particles, alumina particles, and boron nitride particles.

The average thickness of the charge-transporting layer is preferably 5 μm or more and 50 μm or less, more preferably 8 μm or more and 40 μm or less, particularly preferably 10 μm or more and 30 μm or less.

The charge-transporting layer may be formed by: preparing a coating liquid for a charge-transporting layer containing the above-mentioned respective materials and a solvent; forming a coat of the coating liquid; and drying the coat. Examples of the solvent to be used for the coating liquid include an alcohol-based solvent, a ketone-based solvent, an ether-based solvent, an ester-based solvent, and an aromatic hydrocarbon-based solvent. Of those solvents, an ether-based solvent or an aromatic hydrocarbon-based solvent is preferred.

(2) Single-Layer Photosensitive Layer

In one aspect of the present disclosure, when the photosensitive layer is the single-layer photosensitive layer, the butanediol adduct of titanyl phthalocyanine, the charge-generating substance, and the resin are incorporated into the single-layer photosensitive layer. In addition, the following procedure may be adopted: the butanediol adduct of titanyl phthalocyanine is incorporated into the single-layer photosensitive layer, and any other charge-generating substance is further incorporated thereinto. Examples of the other charge-generating substance are the same as the examples of the material in the section “(1) Laminated Photosensitive Layer.” Examples of the charge-transporting substance and the resin are the same as the examples of the materials in the section “(1) Laminated Photosensitive Layer.”

The single-layer photosensitive layer may be formed by: preparing a coating liquid for a photosensitive layer containing the butanediol adduct of titanyl phthalocyanine, the other charge-generating substance, the charge-transporting substance, the resin, and a solvent; forming a coat of the coating liquid; and drying the coat.

<Protective Layer>

In one aspect of the present disclosure, a protective layer may be arranged on the photosensitive layer 1-3. The arrangement of the protective layer can improve the durability of the photosensitive member.

The protective layer preferably contains electroconductive particles and/or a charge-transporting substance, and a resin.

Examples of the electroconductive particles include particles of metal oxides, such as titanium oxide, zinc oxide, tin oxide, and indium oxide.

Examples of the charge-transporting substance include a polycyclic aromatic compound, a heterocyclic compound, a hydrazone compound, a styryl compound, an enamine compound, a benzidine compound, a triarylamine compound, and a resin having a group derived from each of those substances. Of those, a triarylamine compound and a benzidine compound are preferred.

Examples of the resin include a polyester resin, an acrylic resin, a phenoxy resin, a polycarbonate resin, a polystyrene resin, a phenol resin, a melamine resin, and an epoxy resin. Of those, a polycarbonate resin, a polyester resin, and an acrylic resin are preferred.

In addition, the protective layer may be formed as a cured film by polymerizing a composition containing a monomer having a polymerizable functional group. A reaction at that time is, for example, a thermal polymerization reaction, a photopolymerization reaction, or a radiation polymerization reaction. Examples of the polymerizable functional group of the monomer having a polymerizable functional group include an acrylic group and a methacrylic group. A material having charge transportability may be used as the monomer having a polymerizable functional group.

The protective layer may contain an additive, such as an antioxidant, a UV absorber, a plasticizer, a leveling agent, a lubricity-imparting agent, or a wear resistance-improving agent. Specific examples thereof include a hindered phenol compound, a hindered amine compound, a sulfur compound, a phosphorus compound, a benzophenone compound, a siloxane-modified resin, a silicone oil, fluorine resin particles, polystyrene resin particles, polyethylene resin particles, silica particles, alumina particles, and boron nitride particles.

The average thickness of the protective layer is preferably 0.5 μm or more and 10 μm or less, more preferably 1 μm or more and 7 μm or less.

The protective layer may be formed by: preparing a coating liquid for a protective layer containing the above-mentioned respective materials and a solvent; forming a coat of the coating liquid; and drying and/or curing the coat. Examples of the solvent to be used for the coating liquid include an alcohol-based solvent, a ketone-based solvent, an ether-based solvent, a sulfoxide-based solvent, an ester-based solvent, and an aromatic hydrocarbon-based solvent.

[Process Cartridge and Electrophotographic Apparatus]

A process cartridge according to one aspect of the present disclosure integrally supports the electrophotographic photosensitive member that has been described above, and at least one unit selected from the group consisting of a charging unit, a developing unit, a transferring unit, and a cleaning unit, and is removably mounted onto the main body of an electrophotographic apparatus.

In addition, an electrophotographic apparatus according to one aspect of the present disclosure includes the electrophotographic photosensitive member that has been described above, and a charging unit, an exposing unit, a developing unit, and a transferring unit.

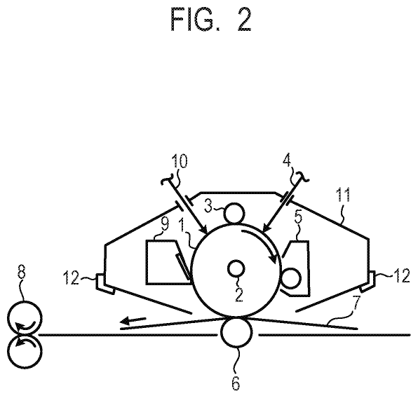

An example of the schematic construction of an electrophotographic apparatus including a process cartridge including an electrophotographic photosensitive member is illustrated in FIG. 2.

An electrophotographic photosensitive member 1 having a cylindrical shape is rotationally driven at a predetermined peripheral speed in a direction indicated by the arrow about an axis 2 as a center. The surface of the electrophotographic photosensitive member 1 is charged to a predetermined positive or negative potential by a charging unit 3. In FIG. 2, a roller charging system based on a roller-type charging member is illustrated, but a charging system such as a corona charging system, a proximity charging system, or an injection charging system may be adopted. The charged surface of the electrophotographic photosensitive member 1 is irradiated with exposure light 4 from an exposing unit (not shown), and hence an electrostatic latent image corresponding to target image information is formed thereon. The electrostatic latent image formed on the surface of the electrophotographic photosensitive member 1 is developed with toner stored in a developing unit 5, and hence a toner image is formed on the surface of the electrophotographic photosensitive member 1. The toner image formed on the surface of the electrophotographic photosensitive member 1 is transferred onto a transfer material 7 by a transferring unit 6. The transfer material 7 onto which the toner image has been transferred is conveyed to a fixing unit 8, is subjected to a treatment for fixing the toner image, and is printed out to the outside of the electrophotographic apparatus. The electrophotographic apparatus may include a cleaning unit 9 for removing a deposit, such as the toner remaining on the surface of the electrophotographic photosensitive member 1 after the transfer. In addition, a so-called cleaner-less system configured to remove the deposit with the developing unit or the like without separate arrangement of the cleaning unit may be used. The electrophotographic apparatus may include an electricity-removing unit configured to subject the surface of the electrophotographic photosensitive member 1 to an electricity-removing treatment with pre-exposure light 10 from a pre-exposing unit (not shown). In addition, a guiding unit 12, such as a rail, may be arranged for removably mounting a process cartridge 11 according to one aspect of the present disclosure onto the main body of the electrophotographic apparatus.

The electrophotographic photosensitive member according to one aspect of the present disclosure can be used in, for example, a laser beam printer, an LED printer, a copying machine, a facsimile, and a multifunctional peripheral thereof.

### EXAMPLES

The present disclosure is described in more detail below by way of Examples and Comparative Examples. The present disclosure is by no means limited to the following Examples, and various modifications may be made without departing from the gist of the present disclosure. In the description of the following Examples, “part(s)” is by mass unless otherwise specified.

[Method of Producing Strontium Titanate Particles]

<Production Example of Strontium Titanate Particles 1>

A hydrous titanium oxide slurry obtained by hydrolyzing an aqueous solution of titanyl sulfate was washed with an alkaline aqueous solution. Next, hydrochloric acid was added to the hydrous titanium oxide slurry to adjust its pH to 0.7. Thus, a titania sol-dispersed liquid was obtained.

An aqueous solution of strontium chloride was added in a molar amount 1.1 times as large as 2.2 mol of the titania sol-dispersed liquid (in terms of titanium oxide) to the dispersed liquid, and the mixture was loaded into a reaction vessel, followed by the purging of air in the vessel with a nitrogen gas. Further, pure water was added to the mixture so that the concentration of the titania sol became 1.1 mol/L in terms of titanium oxide. Next, the materials were stirred and mixed, and the mixture was warmed to 90° C. After that, while ultrasonic vibration was applied to the mixture, 440 mL of a 10 N aqueous solution of sodium hydroxide was added to the mixture over 15 minutes, and then the whole was subjected to a reaction for 20 minutes. Pure water at 5° C. was added to the slurry after the reaction to rapidly cool the slurry to 30° C. or less, and then the supernatant liquid was removed. Further, an aqueous solution of hydrochloric acid having a pH of 5.0 was added to the slurry, and the mixture was stirred for 1 hour. After that, the mixture was repeatedly washed with pure water. Further, the mixture was neutralized with sodium hydroxide, and was filtered with Nutsche, followed by washing with pure water. The resultant cake was dried to provide strontium titanate particles 1.

<Production Example of Strontium Titanate Particles 2>

An aqueous solution of strontium chloride was added in a molar amount 1.2 times as large as 1.0 mol of the titania sol-dispersed liquid (in terms of titanium oxide) to the dispersed liquid, and the mixture was loaded into a reaction vessel, followed by the purging of air in the vessel with a nitrogen gas. Further, pure water was added to the mixture so that the concentration of the titania sol became 0.5 mol/L in terms of the concentration of titanium oxide. Next, the materials were stirred and mixed, and the mixture was warmed to 70° C. After that, while ultrasonic vibration was applied to the mixture, 1,100 mL of a 2 N aqueous solution of sodium hydroxide was added to the mixture over 40 minutes, and then the whole was subjected to a reaction for 20 minutes. The slurry after the reaction was cooled to 30° C. or less, and then the supernatant liquid was removed. Further, an aqueous solution of hydrochloric acid having a pH of 5.0 was added to the slurry, and the mixture was stirred for 1 hour. After that, the mixture was repeatedly washed with pure water. The resultant cake was dried to provide strontium titanate particles 2.

<Production Example of Strontium Titanate Particles 3>

An aqueous solution of strontium chloride was added in a molar amount 1.2 times as large as 0.4 mol of the titania sol-dispersed liquid (in terms of titanium oxide) to the dispersed liquid, and the mixture was loaded into a reaction vessel, followed by the purging of air in the vessel with a nitrogen gas. Further, pure water was added to the mixture so that the concentration of the titania sol became 0.2 mol/L in terms of the concentration of titanium oxide. Next, the materials were stirred and mixed, and the mixture was warmed to 70° C. After that, 600 mL of a 2 N aqueous solution of sodium hydroxide was added to the mixture over 660 minutes, and then the whole was subjected to a reaction for 20 minutes. The slurry after the reaction was cooled to 30° C. or less, and then the supernatant liquid was removed. Further, the slurry was washed with pure water, and the resultant cake was dried to provide strontium titanate particles 3.

<Production Example of Strontium Titanate Particles 4>

An aqueous solution of strontium chloride was added in a molar amount 1.3 times as large as 0.6 mol of the titania sol-dispersed liquid (in terms of titanium oxide) to the dispersed liquid, and the mixture was loaded into a reaction vessel, followed by the purging of air in the vessel with a nitrogen gas. Further, pure water was added to the mixture so that the concentration of the titania sol became 0.1 mol/L in terms of the concentration of titanium oxide. Next, the materials were stirred and mixed, and the mixture was warmed to 70° C. After that, 750 mL of a 2 N aqueous solution of sodium hydroxide was added to the mixture over 900 minutes, and then the whole was subjected to a reaction for 20 minutes. The slurry after the reaction was cooled to 30° C. or less, and then the supernatant liquid was removed. Further, the slurry was washed with pure water, and the resultant cake was dried to provide strontium titanate particles 4.

[Method of Producing Butanediol Adduct of Titanyl Phthalocyanine]

<Method of Producing Amorphous Titanyl Phthalocyanine>

In 100 parts of α-chloronaphthalene, 5.0 parts of o-phthalodinitrile and 2.0 parts of titanium tetrachloride were stirred under heating at 200° C. for 3 hours. After that, the mixture was cooled to 50° C., and the precipitated crystal was separated by filtration. Thus, a dichlorotitanium phthalocyanine paste was obtained. Next, the paste was washed with 100 parts of N,N-dimethylformamide heated to 100° C. under stirring, and was then repeatedly washed with 100 parts of methanol at 60° C. twice, followed by the separation of the paste by filtration. Further, the resultant paste was stirred in 100 parts of deionized water at 80° C. for 1 hour, and was separated by filtration. Thus, a blue titanyl phthalocyanine pigment was obtained. Next, the pigment was dissolved in 30 parts of concentrated sulfuric acid, and the solution was dropped into 300 parts of deionized water at 20° C. under stirring to reprecipitate the pigment. The pigment was filtered out of the mixture and sufficiently washed with water. Thus, amorphous titanyl phthalocyanine was obtained.

<Production Example of Charge-Generating Substance G-1>

150 Parts of α-chloronaphthalene was mixed with 8 parts of the amorphous titanyl phthalocyanine obtained by the above-mentioned method and 0.75 part of 2,3-butanediol (manufactured by Tokyo Chemical Industry Co., Ltd.), and the mixture was stirred at a temperature of 60° C. for 6 hours. After that, the mixture was cooled to room temperature, and then the precipitate was separated by filtration. The precipitate was repeatedly washed with methanol and dried under reduced pressure. Thus, a charge-generating substance G-1 that was a reaction product of titanyl phthalocyanine and 2,3-butanediol was obtained.

The charge-generating substance G-1 showed peaks at m/Z of 576 and 648 in its mass spectrum. In addition, in the IR spectrum of the substance, absorption near 970 cm⁻¹ considered to be derived from a Ti═O structure and absorption near 630 cm⁻¹ considered to be derived from an O—Ti—O structure were observed. It was assumed from the foregoing that the charge-generating substance G-1 was a mixed crystal of 2,3-butanediol adduct of titanyl phthalocyanine and non adduct of titanyl phthalocyanine.

<Production Example of Charge-Generating Substance G-2>

150 Parts of α-chloronaphthalene was mixed with 8 parts of the amorphous titanyl phthalocyanine obtained by the above-mentioned method and 2.0 parts of 2,3-butanediol (manufactured by Tokyo Chemical Industry Co., Ltd.), and the mixture was stirred at a temperature of 180° C. for 6 hours. After that, the mixture was cooled to room temperature, and then the precipitate was separated by filtration. The precipitate was repeatedly washed with methanol and dried under reduced pressure. Thus, a charge-generating substance G-2 that was a reaction product of titanyl phthalocyanine and 2,3-butanediol was obtained.

The charge-generating substance G-2 showed a peak at m/Z of 648 in its mass spectrum. In addition, in the IR spectrum of the substance, absorption near 630 cm⁻¹ considered to be derived from an O—Ti—O structure was observed. It was assumed from the foregoing that the charge-generating substance G-2 was a single crystal of 2,3-butanediol adduct of titanyl phthalocyanine.

<Production Example of Charge-Generating Substance G-3>

150 Parts of α-chloronaphthalene was mixed with 8 parts of the amorphous titanyl phthalocyanine obtained by the above-mentioned method and 0.75 part of 1,2-butanediol (manufactured by Tokyo Chemical Industry Co., Ltd.), and the mixture was stirred at a temperature of 60° C. for 6 hours. After that, the mixture was cooled to room temperature, and then the precipitate was separated by filtration. The precipitate was repeatedly washed with methanol and dried under reduced pressure. Thus, a charge-generating substance G-3 that was a reaction product of titanyl phthalocyanine and 1,2-butanediol was obtained.

The charge-generating substance G-3 showed peaks at m/Z of 576 and 648 in its mass spectrum. In addition, in the IR spectrum of the substance, absorption near 970 cm⁻¹ considered to be derived from a Ti═O structure and absorption near 630 cm⁻¹ considered to be derived from an O—Ti—O structure were observed. It was assumed from the foregoing that the charge-generating substance G-3 was a mixed crystal of 1,2-butanediol adduct of titanyl phthalocyanine and non adduct of titanyl phthalocyanine.

### Example 1

100 Parts of the strontium titanate particles 1 produced by the above-mentioned method and 500 parts of toluene were stirred and mixed, and 0.8 part of N-2-(aminoethyl)-3-aminopropylmethyldimethoxysilane (product name: KBM-602, manufactured by Shin-Etsu Chemical Co., Ltd.) was added as a silane coupling agent to the mixture, followed by stirring for 6 hours. After that, toluene was evaporated under reduced pressure, and the residue was heated and dried at 130° C. for 6 hours to provide surface-treated strontium titanate particles TS-1.

Next, 20 parts of a polyamide resin (product name: AMILAN CM8000, manufactured by Toray Industries, Inc.) was dissolved in a mixed liquid of 180 parts of methanol and 20 parts of ethanol. 80 Parts of the surface-treated strontium titanate particles TS-1 and 0.4 part of 2,3,4-trihydroxybenzophenone (manufactured by Tokyo Chemical Industry Co., Ltd.) serving as an additive were added to the solution, and were dispersed therein with a sand mill apparatus using glass beads each having a diameter of 0.8 mm under an atmosphere at 23±3° C. for 3 hours. After the dispersion, 0.01 part of a silicone oil (product name: SH28PA, manufactured by Dow Corning Toray Co., Ltd.) was added to the dispersed liquid, and the mixture was stirred to provide a coating liquid for an undercoat layer.

The resultant coating liquid for an undercoat layer was applied onto an aluminum cylinder having a diameter of 30 mm and a length of 357.5 mm by dip coating to form a coat, and the resultant coat was heated and dried to form an undercoat layer having a thickness of 2.0 μm.

Next, 20 parts of the charge-generating substance G-1 produced in the foregoing, 10 parts of a polyvinyl butyral resin (product name: #6000-C, manufactured by Denki Kagaku Kogyo K.K.), 700 parts of t-butyl acetate, and 300 parts of 4-methoxy-4-methyl-2-pentanone were mixed, and were dispersed with a sand mill for 10 hours to produce a coating liquid for a charge-generating layer.

The coating liquid for a charge-generating layer was applied onto the undercoat layer by dip coating to form a coat, and the resultant coat was heated and dried to form a charge-generating layer having a thickness of 0.3 μm.

Next, 60 parts of a compound (charge-transporting substance) represented by the following formula (A), 30 parts of a compound (charge-transporting substance) represented by the following formula (B), 10 parts of a compound represented by the following formula (C), 100 parts of a polycarbonate resin (product name: IUPILON Z400, manufactured by Mitsubishi Engineering-Plastics Corporation, bisphenol Z-type polycarbonate), and 0.02 part of a polycarbonate represented by the following formula (D) (viscosity-average molecular weight Mv: 20,000) were dissolved in a mixed solvent of 600 parts of o-xylene and 200 parts of dimethoxymethane. Thus, a coating liquid for a charge-transporting layer was prepared.

The coating liquid for a charge-transporting layer was applied onto the charge-generating layer by dip coating to form a coat, and the resultant coat was heated and dried to form a charge-transporting layer having a thickness of 23 μm.

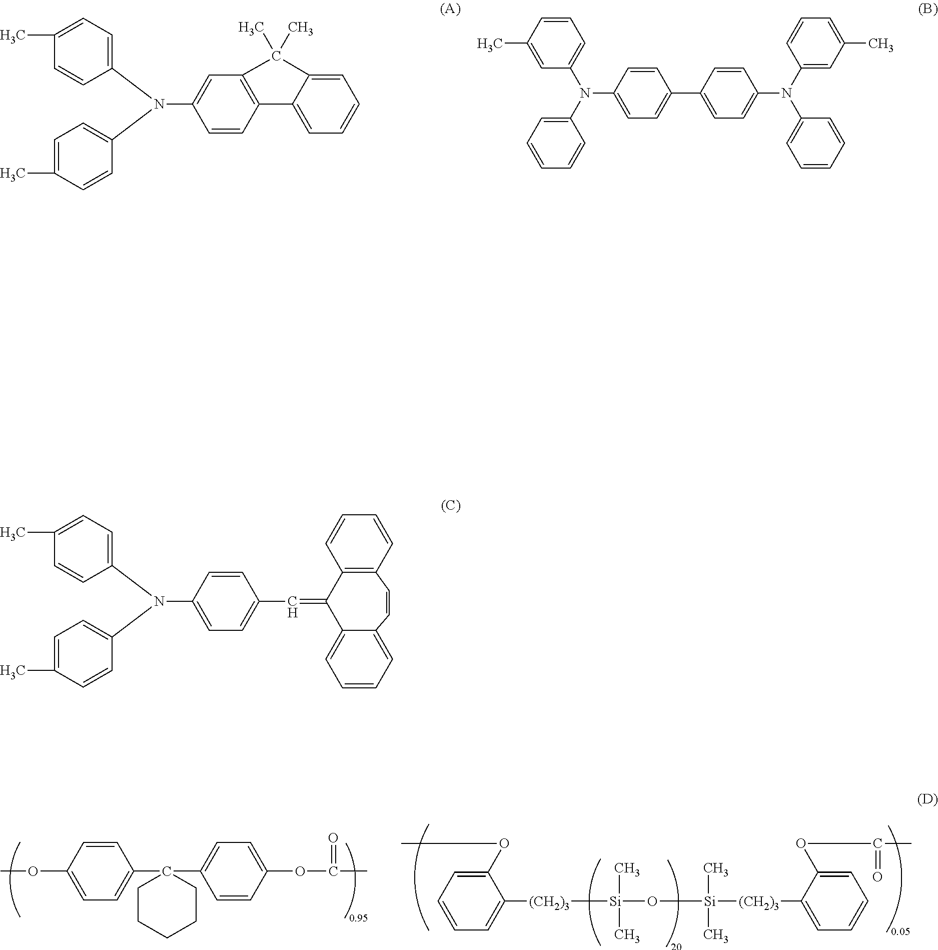

Thus, a photosensitive member 1 was produced.

[Evaluation of Electrophotographic Photosensitive Member]

<Photomemory Evaluation>

The two photosensitive members 1 described above were prepared, and one of the photosensitive members was mounted on the cyan station of a reconstructed machine of an electrophotographic apparatus (copying machine) manufactured by Canon Inc. (product name: iR-ADV C5255) serving as an evaluation apparatus. Under an environment at 23° C. and 50% RH, conditions for a charging apparatus and an image-exposing apparatus were adjusted in advance so that the dark potential (Vd) of the electrophotographic photosensitive member became −700 V and the integrated light quantity of laser light became 0.35 μJ/cm² on the surface of the photosensitive member.

Next, the surface of the other prepared photosensitive member 1 was wrapped with a light-shielding sheet having opened therein a rectangular hole measuring 15 mm in the rotation direction of the photosensitive member by 100 mm in the longitudinal direction of the photosensitive member, and the surface of the photosensitive member exposed from the hole portion of the light-shielding sheet was exposed to white daylight having an illuminance of 2,000 lx for 20 minutes. After that, the wrapped light-shielding sheet was removed, and the photosensitive member was arranged on the cyan station of the evaluation apparatus. Five minutes after the completion of the light exposure, the surface potential of the photosensitive member was measured under the preset conditions.

The absolute value of a difference in light potential between the portion exposed to the white daylight through the hole opened in the light-shielding sheet and the light-shielded portion was adopted as a photomemory. Ranks were set as described below.
A: The absolute value is 0 V or more and less than 10 V.
B: The absolute value is 10 V or more and less than 15 V.
C: The absolute value is 15 V or more and less than 20 V.
D: The absolute value is 20 V or more and less than 25 V.
E: The absolute value is 25 V or more.

The above-mentioned evaluation was used as an approach to evaluating the extent to which a memory phenomenon occurred when the photosensitive member was free of any light-shielding member. The results are shown in Table 1.

<Evaluation of Number-Average Primary Particle Diameter of Strontium Titanate Particles>

The number-average particle diameter of the primary particles of the strontium titanate particles in the undercoat layer was determined as described below.

First, an enlarged photograph of a section of the undercoat layer of the produced electrophotographic photosensitive member is taken with a SEM. The sectional photograph and a sectional photograph obtained by the elemental mapping of the strontium titanate particles with an element-analyzing unit attached to the SEM, such as an X-ray microanalyzer (XMA), are compared to each other. Next, the projected areas of the primary particles of the 100 strontium titanate particles were measured, and the equivalent diameters of circles having the same areas as the measured projected areas of the strontium titanate particles were determined as the primary particle diameters of the strontium titanate particles. The number-average particle diameter of the primary particles of the strontium titanate particles was calculated based on the results. The result is shown in Table 1.

### Examples 2 to 4

Surface-treated strontium titanate particles TS-2 to TS-4 were obtained in the same manner as in Example 1 except that the strontium titanate particles 1 were changed to the strontium titanate particles 2 to 4, respectively. Photosensitive members 2 to 4 were each produced in the same manner as in Example 1 except that the surface-treated strontium titanate particles TS-1 were changed as shown in Table 1, and the photomemory evaluation and the evaluation of the number-average primary particle diameter of the strontium titanate particles were performed. The results are shown in Table 1.

### Example 5

In Example 1, 20 parts of the polyamide resin and 80 parts of the surface-treated strontium titanate particles TS-1 to be used in the coating liquid for an undercoat layer were changed to 33 parts of the polyamide resin and 67 parts of the surface-treated strontium titanate particles TS-1, respectively. A photosensitive member 5 was produced in the same manner as in Example 1 except the foregoing, and the photomemory evaluation and the evaluation of the number-average primary particle diameter of the strontium titanate particles were performed. The results are shown in Table 1.

### Example 6

In Example 1, 20 parts of the polyamide resin and 80 parts of the surface-treated strontium titanate particles TS-1 to be used in the coating liquid for an undercoat layer were changed to 50 parts of the polyamide resin and 50 parts of the surface-treated strontium titanate particles TS-1, respectively. A photosensitive member 6 was produced in the same manner as in Example 1 except the foregoing, and the photomemory evaluation and the evaluation of the number-average primary particle diameter of the strontium titanate particles were performed. The results are shown in Table 1.

### Example 7

100 Parts of the strontium titanate particles 1 produced by the above-mentioned method and 500 parts of toluene were stirred and mixed, and 0.8 part of N-2-(aminoethyl)-3-aminopropylmethyldimethoxysilane (product name: KBM-602, manufactured by Shin-Etsu Chemical Co., Ltd.) was added as a silane coupling agent to the mixture, followed by stirring for 6 hours. After that, toluene was evaporated under reduced pressure, and the residue was heated and dried at 130° C. for 6 hours to provide surface-treated strontium titanate particles TS-5.

Next, 20 parts of a polyamide resin (product name: AMILAN CM8000, manufactured by Toray Industries, Inc.) was dissolved in a mixed liquid of 180 parts of methanol and 20 parts of ethanol. 50 Parts of the surface-treated strontium titanate particles TS-5, 20 parts of titanium oxide particles (product name: MT-500SA, manufactured by Tayca Corporation), and 0.4 part of 2,3,4-trihydroxybenzophenone (manufactured by Tokyo Chemical Industry Co., Ltd.) serving as an additive were added to the solution, and were dispersed therein with a sand mill apparatus using glass beads each having a diameter of 0.8 mm under an atmosphere at 23±3° C. for 3 hours.

After the dispersion, 0.01 part of a silicone oil (product name: SH28PA, manufactured by Dow Corning Toray Co., Ltd.) was added to the dispersed liquid, and the mixture was stirred to provide a coating liquid for an undercoat layer.

In Example 1, the coating liquid for an undercoat layer was changed to the coating liquid for an undercoat layer produced in the foregoing. A photosensitive member 7 was produced in the same manner as in Example 1 except the foregoing, and the photomemory evaluation and the evaluation of the number-average primary particle diameter of the strontium titanate particles were performed. The results are shown in Table 1.

### Example 8

In Example 1, 20 parts of the polyamide resin and 80 parts of the surface-treated strontium titanate particles TS-1 to be used in the coating liquid for an undercoat layer were changed to 60 parts of the polyamide resin and 40 parts of the surface-treated strontium titanate particles TS-1, respectively. A photosensitive member 8 of Example 8 was produced in the same manner as in Example 1 except the foregoing, and the photomemory evaluation and the evaluation of the number-average primary particle diameter of the strontium titanate particles were performed. The results are shown in Table 1.

### Examples 9 and 10

In Example 1, the charge-generating substance G-1 to be used in the coating liquid for a charge-generating layer was changed as shown in Table 1. Photosensitive members 9 and 10 were produced in the same manner as in Example 1 except the foregoing, and the photomemory evaluation and the evaluation of the number-average primary particle diameter of the strontium titanate particles were performed. The results are shown in Table 1.

### Example 11

The process up to the formation of the charge-generating layer was performed in the same manner as in Example 1.

A coating liquid for a charge-transporting layer was prepared in the same manner as in Example 1. The coating liquid for a charge-transporting layer was applied onto the charge-generating layer by dip coating to form a coat, and the resultant coat was heated and dried to form a charge-transporting layer having a thickness of 18 μm.

Next, 1.65 parts of a resin having a repeating structural unit represented by the following formula (M1) and a repeating structural unit represented by the following formula (M2) (weight-average molecular weight: 130,000, copolymerization ratio (M1)/(M2)=1/1 (molar ratio)) was dissolved in a mixed solvent of 40 parts of 1,1,2,2,3,3,4-heptafluorocyclopentane (product name: ZEORORA H, manufactured by Zeon Corporation) and 55 parts of 1-propanol. After that, 30 parts of ethylene tetrafluoride resin powder (product name: RUBURON L-2, manufactured by Daikin Industries, Ltd.) was added to the liquid, and the liquid was passed through a high-pressure disperser (product name: MICROFLUIDIZER M-110EH, manufactured by Microfluidics Corporation) to provide a dispersed liquid.

After that, 52.0 parts of a hole-transportable compound represented by the following formula (E), 16.0 parts of a compound represented by the following formula (F) (ARONIX M-315, manufactured by Toagosei Co., Ltd.), 2.0 parts of a compound represented by the following formula (G) (manufactured by Sigma-Aldrich), 0.75 part of a siloxane-modified acrylic compound (BYK-3550, manufactured by BYK-Chemie Japan), 35 parts of 1,1,2,2,3,3,4-heptafluorocyclopentane, and 15 parts of 1-propanol were added to the dispersed liquid, and the mixture was filtered with a polyflon filter (product name: PF-040, manufactured by Advantec Toyo Kaisha, Ltd.) to prepare a coating liquid for a protective laver.

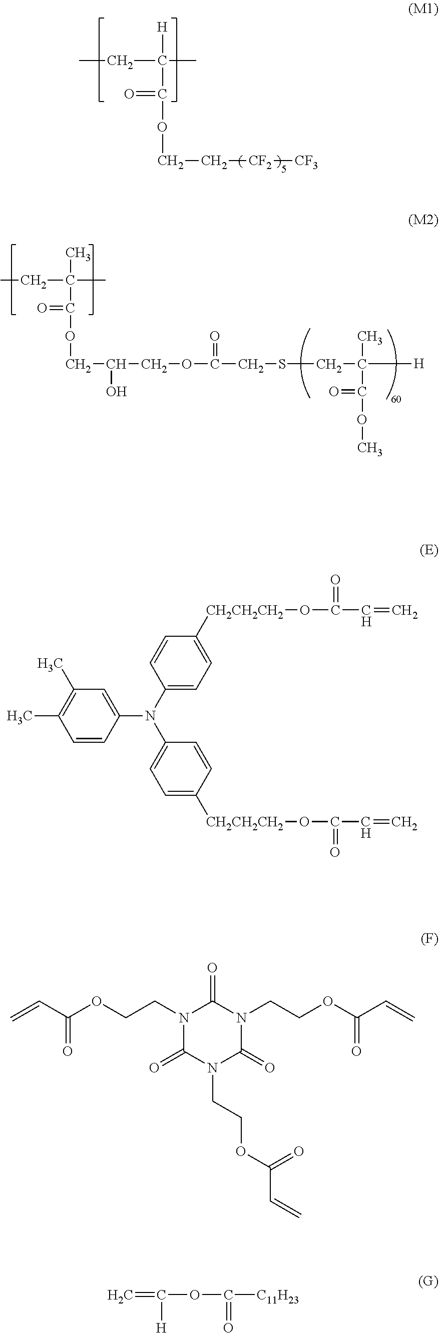

The coating liquid for a protective layer was applied onto the charge-transporting layer by dip coating, and the resultant coat was dried for 5 minutes at 40° C. After the drying, under a nitrogen atmosphere, the coat was irradiated with electron beams under the conditions of an acceleration voltage of 70 kV and an absorbed dose of 15 kGy for 1.6 seconds. After that, under a nitrogen atmosphere, a heating treatment was performed for 15 seconds under such a condition that the temperature of the coat became 135° C. An oxygen concentration during a time period from the electron beam irradiation to the heating treatment for 15 seconds was 15 ppm. Next, in air, a heating treatment was performed for 1 hour under such a condition that the temperature of the coat became 105° C. Thus, a protective layer having a thickness of 5 μm was formed.

Thus, a photosensitive member 11 was produced, and the photomemory evaluation and the evaluation of the number-average primary particle diameter of the strontium titanate particles were performed. The results are shown in Table 1.

### Comparative Example 1

In Example 1, 20 parts of the polyamide resin and 80 parts of the surface-treated strontium titanate particles TS-1 to be used in the coating liquid for an undercoat layer were changed to 25 parts of the polyamide resin and 75 parts of titanium oxide particles (product name: MT-500SA, manufactured by Tayca Corporation), respectively. A comparative photosensitive member 1 of Comparative Example 1 was produced in the same manner as in Example 1 except the foregoing, and the photomemory evaluation was performed. The results are shown in Table 1.

### Comparative Example 2

In Example 10, 20 parts of the polyamide resin and 80 parts of the surface-treated strontium titanate particles TS-1 to be used in the coating liquid for an undercoat layer were changed to 25 parts of the polyamide resin and 75 parts of titanium oxide particles (product name: MT-500SA, manufactured by Tayca Corporation), respectively. A comparative photosensitive member 2 of Comparative Example 2 was produced in the same manner as in Example 10 except the foregoing, and the photomemory evaluation was performed. The results are shown in Table 1.

### Comparative Example 3

In Example 11, 20 parts of the polyamide resin and 80 parts of the surface-treated strontium titanate particles TS-1 to be used in the coating liquid for an undercoat layer were changed to 25 parts of the polyamide resin and 75 parts of titanium oxide particles (product name: MT-500SA, manufactured by Tayca Corporation), respectively. A comparative photosensitive member 3 of Comparative Example 3 was produced in the same manner as in Example 11 except the foregoing, and the photomemory evaluation was performed. The results are shown in Table 1.

TABLE 1

| | | Undercoat layer | | | | | | | |
|---|---|---|---|---|---|---|---|---|---|
| | | | | | Content of | | | | |
| | | | | Number-average | strontium | | | | |
| | | Particles to be incorporated | | particle diameter | titanate | | | | |
| | | into undercoat layer | | of primary | particles | Charge-generating | | | |
| | | Strontium | | particles of | with respect to | layer | | Evaluation | |
| | Photosensitive | titanate | Other | strontium titanate | total amount of | Charge-generating | Protective | Photomemory | |
| Example | member | particles | particles | particles (nm) | undercoat layer | substance | layer | [V] | Rank |
| Example 1 | Photosensitive | TS-1 | — | 35 | 80 mass% | G-1 | Absent | 5 | A |
| | member 1 | | | | | | | | |
| Example 2 | Photosensitive | TS-2 | — | 95 | 80 mass% | G-1 | Absent | 6 | A |
| | member 2 | | | | | | | | |
| Example 3 | Photosensitive | TS-3 | — | 150 | 80 mass% | G-1 | Absent | 8 | A |
| | member 3 | | | | | | | | |
| Example 4 | Photosensitive | TS-4 | — | 200 | 80 mass% | G-1 | Absent | 12 | B |
| | member 4 | | | | | | | | |
| Example 5 | Photosensitive | TS-1 | — | 35 | 67 mass% | G-1 | Absent | 6 | A |
| | member 5 | | | | | | | | |
| Example 6 | Photosensitive | TS-1 | — | 35 | 50 mass% | G-1 | Absent | 8 | A |
| | member 6 | | | | | | | | |
| Example 7 | Photosensitive | TS-5 | MT-500SA | 35 | 50 mass% | G-1 | Absent | 8 | A |
| | member 7 | | | | | | | | |
| Example 8 | Photosensitive | TS-1 | — | 35 | 40 mass% | G-1 | Absent | 13 | B |
| | member 8 | | | | | | | | |
| Example 9 | Photosensitive | TS-1 | — | 35 | 80 mass% | G-3 | Absent | 10 | B |
| | member 9 | | | | | | | | |
| Example 10 | Photosensitive | TS-1 | — | 35 | 80 mass% | G-2 | Absent | 11 | B |
| | member 10 | | | | | | | | |
| Example 11 | Photosensitive | TS-1 | — | 35 | 80 mass% | G-1 | Present | 6 | A |
| | member 11 | | | | | | | | |
| Comparative | Comparative | — | MT-500SA | — | 75 mass% | G-1 | Absent | 21 | D |
| Example 1 | photosensitive | | | | | | | | |
| | member 1 | | | | | | | | |
| Comparative | Comparative | — | MT-500SA | — | 75 mass% | G-2 | Absent | 27 | E |
| Example 2 | photosensitive | | | | | | | | |
| | member 2 | | | | | | | | |
| Comparative | Comparative | — | MT-500SA | — | 75 mass% | G-1 | Present | 23 | D |
| Example 3 | photosensitive | | | | | | | | |
| | member 3 | | | | | | | | |

As shown in Table 1, the occurrence of a photomemory was suppressed by using the electrophotographic photosensitive member according to one aspect of the present disclosure in which the undercoat layer contained the strontium titanate particles and the photosensitive layer contained the butanediol adduct of titanyl phthalocyanine, and the process cartridge and the electrophotographic apparatus each including the electrophotographic photosensitive member according to one aspect of the present disclosure.

According to one aspect of the present disclosure, in the case where the photosensitive layer contains the butanediol adduct of titanyl phthalocyanine, when the undercoat layer contains the strontium titanate particles, the electrophotographic photosensitive member excellent in suppression of the occurrence of a photomemory, and the process cartridge and the electrophotographic apparatus each including the electrophotographic photosensitive member can be provided.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2018-201293, filed Oct. 25, 2018, which is hereby incorporated by reference herein in its entirety.

What is claimed is:

1. An electrophotographic photosensitive member comprising in this order:
an electroconductive support;
an undercoat layer; and
a photosensitive layer,
wherein the undercoat layer contains strontium titanate particles and a binder resin, and the photosensitive layer contains a butanediol adduct of titanyl phthalocyanine.

2. The electrophotographic photosensitive member according to claim 1, wherein the butanediol adduct of titanyl phthalocyanine is represented by the following formula (1): 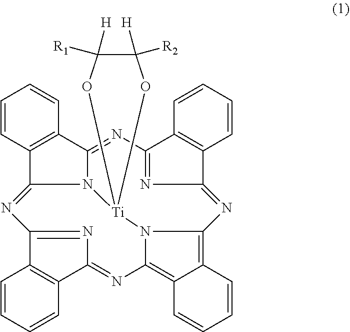
in the formula (1), R₁ and R₂ each represent a hydrogen atom, or an alkyl group having 2 or less carbon atoms, and a total number of carbon atoms of R₁ and R₂ is 2.

3. The electrophotographic photosensitive member according to claim 1, wherein the butanediol adduct of titanyl phthalocyanine is represented by the following formula (2).

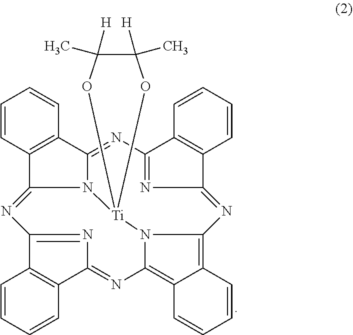

4. The electrophotographic photosensitive member according to claim 1, wherein the photosensitive layer further contains non adduct of titanyl phthalocyanine.

5. The electrophotographic photosensitive member according to claim 4, wherein the non adduct of titanyl phthalocyanine is represented by the following formula (3).

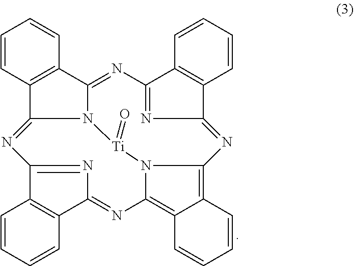

6. The electrophotographic photosensitive member according to claim 1, wherein a content of the strontium titanate particles with respect to a total mass of the undercoat layer is 50 mass % or more.

7. The electrophotographic photosensitive member according to claim 1, wherein a number-average particle diameter of primary particles of the strontium titanate particles is 150 nm or less.

8. A process cartridge comprising:
an electrophotographic photosensitive member; and
at least one unit selected from the group consisting of a charging unit, a developing unit, and a cleaning unit,
the process cartridge integrally supporting the electrophotographic photosensitive member and the at least one unit, and being removably mounted onto a main body of an electrophotographic apparatus,
wherein the electrophotographic photosensitive member includes an electroconductive support, an undercoat layer, and a photosensitive layer in the stated order, the undercoat layer contains strontium titanate particles and a binder resin, and the photosensitive layer contains a butanediol adduct of titanyl phthalocyanine.

9. An electrophotographic apparatus comprising:
an electrophotographic photosensitive member;
a charging unit;
an exposing unit;
a developing unit; and
a transferring unit,
wherein the electrophotographic photosensitive member includes an electroconductive support, an undercoat layer, and a photosensitive layer in the stated order, the undercoat layer contains strontium titanate particles and a binder resin, and the photosensitive layer contains a butanediol adduct of titanyl phthalocyanine.
